(19) United States
(12) Patent Application Publication
(10) Pub. No.: US 2002/0125278 A1
(43) Pub. Date: Sep. 12, 2002

(54) Carrier for percussion instruments and the like

(76) Inventor: C. Edwin Wagmild, Somers, MT (US)

Correspondence Address: Burkhart & Burkhart, Patent Attorneys, 940 Dakota Avenue, Whitefish, MT, 59937, US

(21) Appl. No.: 09/805,689

(22) Filed: Mar. 12, 2001

(51) Int. Cl. A45F 5/00; G10D 13/02

(52) U.S. Cl. 224/268; 224/664; 224/910; 224/271; 224/646; 224/623; 84/421

(57) ABSTRACT

A carrier assembly is adapted for securing a carried article to a human user. The carrier assembly includes a first securing strap secured around the torso of the user at a point below the user's underarms. A second securing strap is secured around the torso of the user at a point just above the user's pelvis. An article attachment mechanism connected between the first securing strap and the second securing strap. In an embodiment, the article attachment mechanism includes an upper attachment assembly connected to the first securing strap, and a lower attachment assembly connected to the second securing strap. A pair of upper securing brackets can be connected to the upper attachment assembly, with a pair of lower securing brackets connected to the lower attachment assembly. First and second connector rods are connected between respective upper securing brackets and lower securing brackets. An adjustment mechanism can be provided on each of the securing brackets. The adjusting mechanism can selectively vary the effective vertical span of the article attachment mechanism.

### FIELD OF THE INVENTION

The present invention relates generally to human borne carriers for various articles. Specifically, the present invention relates to carriers having support arrangements for reducing upper body strain inherent in article carrying, particularly in carrying musical instruments such as percussion instruments.

### BACKGROUND OF THE INVENTION

The importance of ergonomics in lifting and carrying cannot be overemphasized. Incorrect design can result in excessive stress on the spine and upper body, with the resulting incalculable cost in treatment and lost time. Research has shown that load distribution that maintains as much as is possible the body's natural center of gravity helps to prevent such stress-related injuries.

This is particularly important in those instances where loads are carried on the upper torso. A prime example is in marching band instruments, such as percussion instruments. It is not uncommon for such instruments to include several drums and other instruments, with the entire assembly weighing in excess of fifty pounds. Unfortunately, known carriers adapted to these applications apply at least some of the load to the upper back and shoulder area, with the resulting excessive stress noted previously being inevitable.

Not surprisingly, carrier devices have been the subject of inventive activity as reflected in the patent literature. For example, U.S. Pat. No. 5,772,091 to Lackner is directed to a support apparatus for supporting the weight of a musical instrument such as a saxophone on the back and hips of a musician. A clip engages a rear portion of a musician's belt or pants. A pair of substantially rigid members extend from the clip and contact the musician's back. The substantially rigid members each include a curved portion, opposite the clip, that extends over and at least partially around the shoulders of a musician. The distal end of each member lies adjacent a front portion of the musician. A strap assembly is connected to the distal ends of the substantially rigid members. A musical instrument clip is connected to the strap assembly and releasably attaches an instrument such as a saxophone to the apparatus.

In another example, U.S. Pat. No. 4,453,442 to LaFlame discusses a carrier for a percussion instrument. The carrier includes a belly plate with an instrument carrier extending outwardly therefrom to supply an instrument in an overhanging position from a person. A rigid band extends along one or both sides of the person at the waistline area from the belly plate to the back of the person. In one embodiment, a back-plate riser arm angles upwardly to traverse the spine of a person at an angle at the thoracic region generally below the scapula region. In a second embodiment, the same area of a person's back is traversed by a back-plate riser arm extending from a back section of the rigid band. A pad assembly is adjustably positioned on the riser arms to engage the person's back.

While each of these patented devices offers some advantages over standard carriers, it can be seen that the need exists for a simple, inexpensive, carrier assembly that effectively supports carried loads while minimizing the potential for damage to the back and upper torso of the user.

### SUMMARY OF THE INVENTION

These and other objects are achieved by providing a carrier assembly for securing a carried article to a human user. The carrier assembly includes a first securing strap secured around the torso of the user at a point below the user's underarms. A second securing strap is secured around the torso of the user at a point just above the user's pelvis. An article attachment mechanism connected between the first securing strap and the second securing strap.

In an embodiment, the article attachment mechanism includes an upper attachment assembly connected to the first securing strap, and a lower attachment assembly connected to the second securing strap. A pair of upper securing brackets can be connected to the upper attachment assembly, with a pair of lower securing brackets connected to the lower attachment assembly. First and second connector rods are connected between respective upper securing brackets and lower securing brackets. An adjustment mechanism can be provided on each of the securing brackets. The adjusting mechanism can selectively vary the effective vertical span of the article attachment mechanism.

The lower attachment assembly can include a lower connector plate to which the lower securing brackets are connected. The upper attachment assembly can include an upper connector plate to which the upper securing brackets are connected. In one embodiment, at least one hook member is secured to the upper connector plate, and an article rest assembly secured to the lower connector plate. In another embodiment, a pair of hook members extend from lower ends of the respective connector rods. In yet another embodiment, a pair of hook members are secured to the lower connector plate, and an article rest assembly is secured to the lower connector plate at a location between the pair of hook members.

First and second adjustable buckles can be connected to the first and second securing straps.

The features of the invention believed to be patentable are set forth with particularity in the appended claims. The invention itself, however, both as to organization and method of operation, together with further objects and advantages thereof, may best be understood by reference to the following description taken in conjunction with the accompanying drawings.

### BRIEF DESCRIPTION OF THE DRAWINGS

FIG. 1 is a schematic perspective view of a carrier assembly constructed in accordance with the principles discussed herein.

FIG. 2 is a section taken along lines II-II of FIG. 1.

FIG. 3 is a section taken along lines III-III of FIG. 1.

FIG. 4 is a section taken along lines IV-IV of FIG. 1.

FIG. 5 is a schematic perspective view of an alternative carrier assembly constructed in accordance with the principles discussed herein.

FIG. 6 is a schematic perspective view of an alternative carrier assembly constructed in accordance with the principles discussed herein.

FIG. 7 is a schematic side view of a carrier assembly constructed in accordance with the principles discussed herein attached to a user.

FIG. 8 is a schematic perspective view of an alternative carrier assembly constructed in accordance with the principles discussed herein.

### DETAILED DESCRIPTION OF THE INVENTION

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

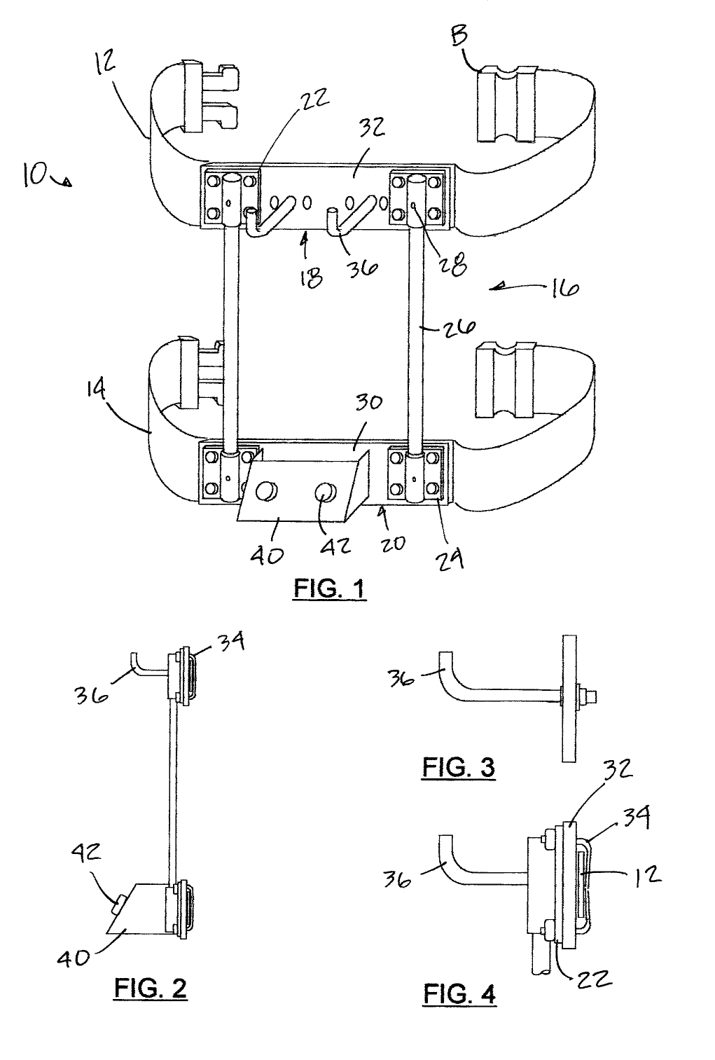

A carrier assembly 10 constructed in accordance with the principles of the present invention is shown in FIG. 1. Although the carrier assembly 10 finds particular utility in conjunction with carrying percussion instruments, the embodied principles are pertinent to any number of applications in which a load is to be carried on the human body. Examples include, but are not limited to, carrying infants, containers for harvesting produce, or any other load typically suspended from the upper torso of the user.

The carrier assembly 10 includes a first securing strap 12 adapted to be secured around the torso of the user at a point below the user's underarms. A second securing strap 14 is secured around the torso of the user at a point just above the user's pelvis. The securing straps can be fabricated from any suitable strong, flexible material, such as nylon webbing. First and second adjustable buckles B, such as parachute buckles, can be connected to the first and second securing straps.

An article attachment mechanism 16 is connected between the first securing strap 12 and the second securing strapl4. In the FIG. 1 embodiment, the article attachment mechanism 16 includes an upper attachment assembly 18 connected to the first securing strap 12. A lower attachment assembly 20 is connected to the second securing strap 14. A pair of upper securing brackets 22 are connected to the upper attachment assembly 18, and a pair of lower securing brackets 24 are connected to the lower attachment assembly 20. The securing brackets can be connected to the attachment assemblies by any suitable method, such as threaded nut and bolt assemblies, or by welding.

First and second connector rods 26 are connected between respective upper securing brackets and lower securing brackets. An adjustment mechanism 28, such as a set screw, can be provided on each of the securing brackets 22, 24. The adjusting mechanism 28 can selectively vary the effective vertical span of the article attachment mechanism 16.

The lower attachment assembly 20 includes a lower connector plate 30 to which the lower securing brackets 24 are connected. The upper attachment assembly 18 includes an upper connector plate 32 to which the upper securing brackets 22 are connected. The securing brackets are connected to the connector plates by threaded u-bolt assemblies 34 (FIG. 2). The indented closed end of the u-bolts 34 pass behind the connector plates, providing guides for the upper and lower securing straps 12, 14. Although the upper and lower connector plates are shown relatively straight, it is contemplated that they could be contoured to closely fit the user's body. This could be accomplished by bending or molding the plates into a curve during fabrication, or by the user bending the plates to provide a custom fit.

In the FIG. 1 embodiment, hook members 36 are secured to the upper connector plate 32. A plurality of adjustment holes 38 are provided to permit horizontal adjustment of the hook members 36. An article rest assembly 40, including an adjustable rest pad 42, is secured to the lower connector plate 30. The hook members 36 and rest assembly 40 are configured to interact with standard percussion mounting hardware such as that manufactured by YAMAHA PERCUSSION, INC.

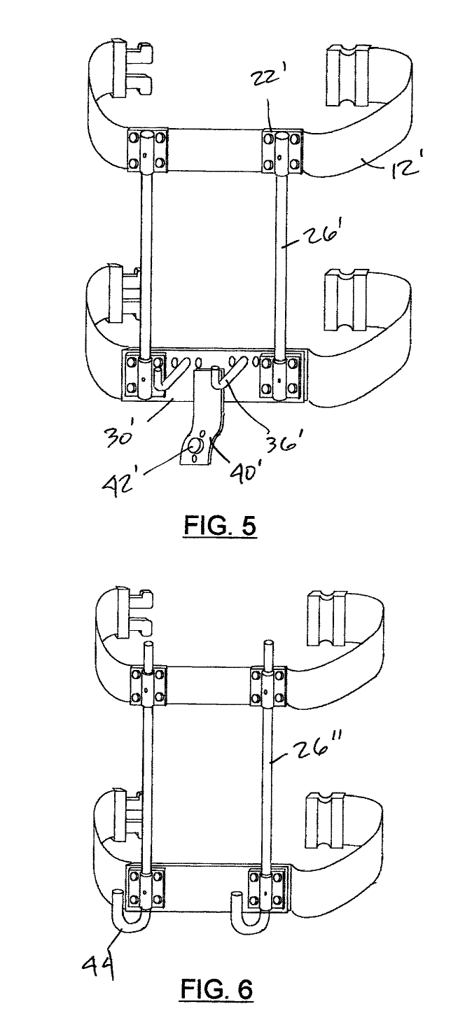

In an alternative embodiment shown in FIG. 5, hook members 36′ are secured to the lower connector plate 30′. An article rest assembly 40′, including an adjustable rest pad 42′, is secured to the lower connector plate 30′ between the hook members 36′. The hook members 36′ and rest assembly 40′ are configured to interact with another standard percussion mounting hardware such as that manufactured by YAMAHA PERCUSSION, INC. It is to be noted that the upper connector plate has been eliminated in the FIG. 5 embodiment, with the securing strap 12′ extending between the upper securing brackets 22′

In yet another embodiment illustrated in FIG. 6, a pair of hook members 44 extend from lower ends of the respective connector rods 26″. The hook members 44 can be adapted and adjusted to receive a variety of article mounting mechanisms, such 5 as handles, brackets, straps, etc.

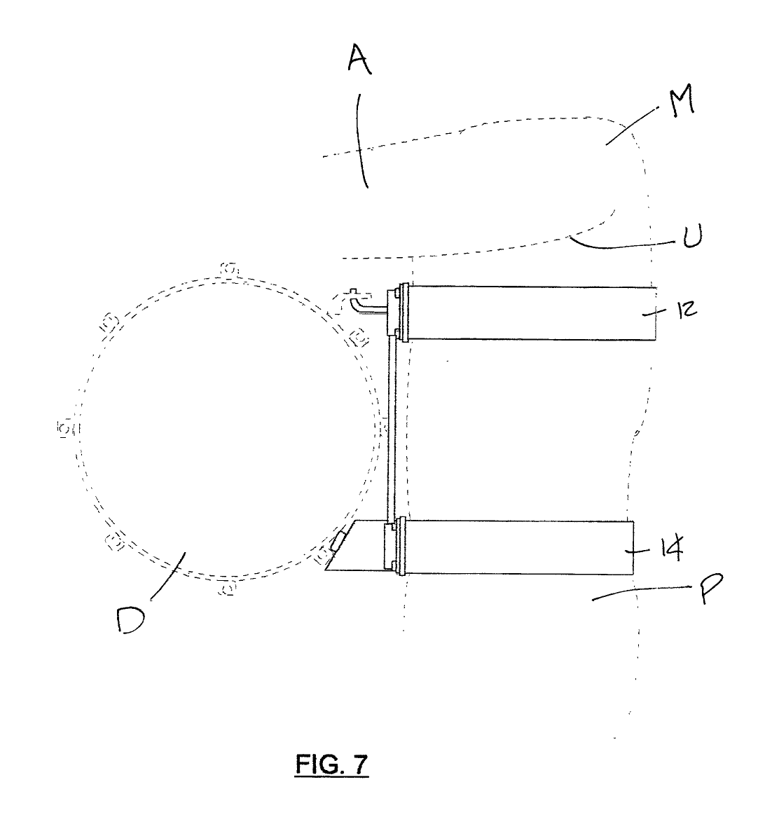

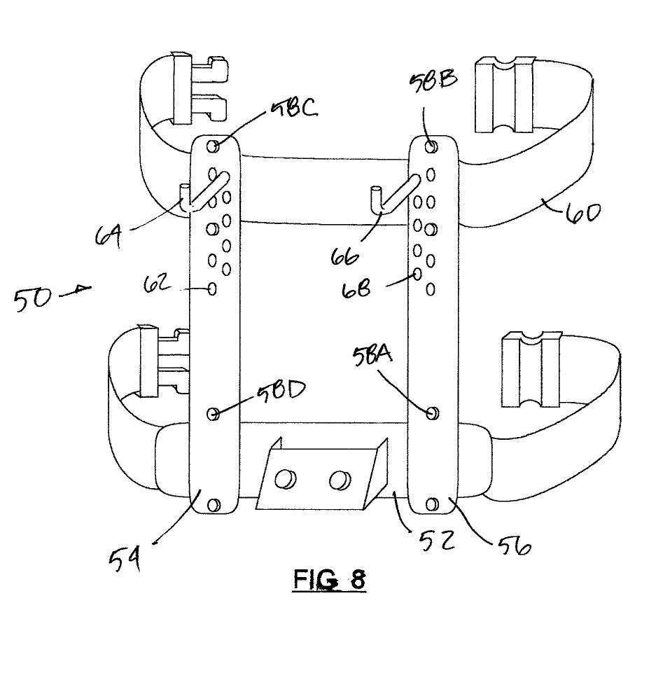

FIG. 7 illustrates the carrier assembly 10 in place on a musician M. The upper securing strap 12 is below the underarms U of the musician M, and the lower securing strap 14 is just above the pelvis P of the musician M. The article attachment mechanism 16 connects the securing straps. This arrangement distributes all of the weight of the percussion instrument D below the underarms U of the musician M, with most of the load being borne in the pelvic area P. This reduces stress on the upper torso and spine of the musician M, while leaving the arms A of the musician M unrestricted. This substantially expands the range of playing and marching technique available to the musician M. In other applications, the present invention allows for increased range of motion for reaching during, e.g., harvesting of produce, and substantially reduces fatigue and stress.

FIG. 8 illustrates yet another embodiment of the present invention, in which a carrier assembly 50 includes a bottom plate 52 connecting a pair of vertical plates 54, 56. The bottom plate 52 is connected to the vertical plates 54, 56 via u-bolt assemblies 58a, 58b, 58c, and 58d similar to those illustrated in the previously-described embodiments. The u-bolt assemblies can be selectively loosened and repositioned to adjust their placement on the upper strap 60 and bottom plate 52, respectively. Height adjustment of the upper strap 60 is accomplished by placement of the u-bolt assemblies 58b and 58c in various combinations of holes 62 formed on the vertical plates 54, 56. Adjustment of the vertical position of hooks 64, 66 can be accomplished by placement of the hooks 64, 66 in the holes 68.

Although the present invention has been described with reference to specific embodiments, those of skill in the art will recognize that changes may be made thereto without departing from the scope and spirit of the invention as defined by the appended claims.

What is claimed is:

1. A carrier assembly for securing a carried article to a human user, the carrier assembly comprising the following:
a first securing strap adapted and constructed to be secured around the torso of the user at a point below the user's underarms;
a second securing strap adapted and constructed to be secured around the torso of the user at a point just above the user's pelvis; and
an article attachment mechanism connected between the first securing strap and the second securing strap.

2. A carrier assembly according to claim 1, wherein the article attachment mechanism comprises the following:
an upper attachment assembly connected to the first securing strap; and
a lower attachment assembly connected to the second securing strap.

3. A carrier assembly according to claim 2, further comprising the following:
a pair of upper securing brackets connected to the upper attachment assembly;
a pair of lower securing brackets connected to the lower attachment assembly; and
first and second connector rods connected between respective upper securing brackets and lower securing brackets.

4. A carrier assembly according to claim 3, further comprising an adjustment mechanism on each of the securing brackets, the adjusting mechanism being adapted and constructed to selectively vary the effective vertical span of the article attachment mechanism.

5. A carrier assembly according to claim 3, wherein the lower attachment assembly comprises a lower connector plate to which the lower securing brackets are connected.

6. A carrier assembly according to claim 5, wherein the upper attachment assembly comprises an upper connector plate to which the upper securing brackets are connected.

7. A carrier assembly according to claim 6, wherein the article attachment mechanism further comprises the following:
at least one hook member secured to the upper connector plate; and
an article rest assembly secured to the lower connector plate.

8. A carrier assembly according to claim 6, wherein the article attachment mechanism further comprises a pair of hook members extending from lower ends of the respective connector rods.

9. A carrier assembly according to claim 5, wherein the article attachment mechanism further comprises the following:
a pair of hook members secured to the lower connector plate; and
an article rest assembly secured to the lower connector plate at a location between the pair of hook members.

10. A carrier assembly according to claim 1, further comprising first and second adjustable buckles respectively connected to the first and second securing straps.

11. An instrument carrier assembly for securing a musical instrument to a mobile human musician, the carrier assembly comprising the following:
a first securing strap adapted and constructed to be secured around the torso of the musician at a point below the musician's underarms;
a second securing strap adapted and constructed to be secured around the torso of the musician at a point just above the musician's pelvis; and
an instrument attachment mechanism connected between the first securing strap and the second securing strap;
whereby the musician retains substantially unrestricted use of the musician's arms.

12. An instrument carrier assembly according to claim 11, wherein the article attachment mechanism comprises the following:
an upper attachment assembly connected to the first securing strap; and
a lower attachment assembly connected to the second securing strap.

13. An instrument carrier assembly according to claim 12, further comprising the following:
a pair of upper securing brackets connected to the upper attachment assembly;
a pair of lower securing brackets connected to the lower attachment assembly; and
first and second connector rods connected between respective upper securing brackets and lower securing brackets.

14. An instrument carrier assembly according to claim 13, further comprising an adjustment mechanism on each of the securing brackets, the adjusting mechanism being adapted and constructed to selectively vary the effective vertical span of the instrument attachment mechanism.

15. An instrument carrier assembly according to claim 13, wherein the lower attachment assembly comprises a lower connector plate to which the lower securing brackets are connected.

16. An instrument carrier assembly according to claim 15, wherein the upper attachment assembly comprises an upper connector plate to which the upper securing brackets are connected.

17. An instrument carrier assembly according to claim 16, wherein the instrument attachment mechanism further comprises the following:
at least one hook member secured to the upper connector plate; and
an article rest assembly secured to the lower connector plate.

18. An instrument carrier assembly according to claim 16, wherein the instrument attachment mechanism further comprises a pair of hook members extending from lower ends of the respective connector rods.

19. An instrument carrier assembly according to claim 15, wherein the instrument attachment mechanism further comprises the following:
a pair of hook members secured to the lower connector plate; and
an article rest assembly secured to the lower connector plate at a location between the pair of hook members.

20. An instrument carrier assembly according to claim 11, further comprising first and second adjustable buckles respectively connected to the first and second securing straps.
